(19) United States
(12) Patent Application Publication
(10) Pub. No.: US 2026/0087660 A1
(43) Pub. Date: Mar. 26, 2026

(54) SYSTEMS AND METHODS FOR SITTING POSTURE EVALUATION

(71) Applicant: ALIGNED AI LLC, Cupertino, CA (US)

(72) Inventor: Atharv NAPHADE, Cupertino, CA (US)

(73) Assignee: ALIGNED AI LLC, Cupertino, CA (US)

(21) Appl. No.: 18/915,320

(22) Filed: Oct. 14, 2024

Related U.S. Application Data
(60) Provisional application No. 63/697,434, filed on Sep. 20, 2024.

(51) Int. Cl. G06T 7/70

(52) U.S. Cl. CPC G06T 7/70

(57) ABSTRACT

The present disclosure provides a system and method for sitting posture evaluation. The method may include when a user is sitting in front of a digital device that is equipped with a camera facing the user, obtaining one or more image frames of the user captured by the camera; and evaluating, based on the one or more image frames of the user, a sitting posture of the user using a posture evaluation model.

### CROSS-REFERENCE TO RELATED APPLICATIONS

This application claims priority of U.S. Provisional Patent Application No. 63/697,434, filed on Sep. 20, 2024, the contents of which are hereby incorporated by reference.

### TECHNICAL FIELD

The disclosure generally relates to the field of evaluating body posture, and more particularly, relates to systems and methods for sitting posture evaluation.

### BACKGROUND

Most working people and students are spending increasingly large time in front of their laptops/desktops/IPADs as part of doing their work or studying. Long hours in front of such devices make it highly likely that unhealthy habits in terms of posture emerge. Over time if this is coupled with lack of exercise and strength training, this leads to serious issues such as scoliosis and debilitating neck pain. Therefore, it is desired to provide a system and method for automatic sitting posture evaluation and sitting posture alignment recommendation for maximum wellness while using a digital device equipped with a camera.

### SUMMARY

According to a first aspect of the present disclosure, a system for sitting posture evaluation is provided. The system comprises at least one storage device storing executable instructions for sitting posture evaluation and at least one processor in communication with the at least one storage device. When executing the executable instructions, the at least one processor is configured to cause the system to perform operations including when a user is sitting in front of a digital device that is equipped with a camera facing the user, obtaining one or more image frames of the user captured by the camera; and evaluating, based on the one or more image frames of the user, a sitting posture of the user using a posture evaluation model.

In some embodiments, the obtaining one or more image frames of the user includes: in response to the user accessing the system via a browser to allow the system to connect to the camera, controlling the camera to capture the one or more image frames.

In some embodiments, the user accesses the system through an Internet connection, and the system continues to perform the operations even if the Internet connection is disconnected.

In some embodiments, after obtaining one or more frames of the user, the at least one processor is further configured to cause the system to perform operations including scaling each frame of the one or more frames of the user in terms of a threshold size.

In some embodiments, the posture evaluation model includes a 3D pose detection model at least configured to detect multiple 3D human pose keypoints in each image frame of the one or more image frames; and a posture metric determination model configured to determine one or more posture metrics at least based on the multiple 3D human pose keypoints in the each image frame, wherein an output layer of the 3D pose detection model is connected to an input layer of the posture metric determination model.

In some embodiments, the 3D pose detection model is further configured to detect one or more aspects of an environment in which the user is located.

In some embodiments, the one or more aspects of the environment include an edge of a desk or a location of an object in which the user is sitting.

In some embodiments, the one or more posture metrics include at least one of:
an elbow height relative to the desk; a height of each shoulder of the user relative to the user's neck; an angle formed by the user's shoulders and nose, with the nose as a vertex; angles formed by the user's legs, bottom of the user's spine, and middle of the neck, with the bottom of the spine as a vertex; a distance between the user and the desk; relative heights of the user's elbows, hands, and shoulders; how far back the shoulders are relative to a front side of the user's skull; or an angle of neck lean from the bottom of the spine, the middle of the neck, and the front side of the skull, with the middle of the neck as a vertex.

In some embodiments, the evaluating, based on the one or more image frames of the user, a sitting posture of the user using a posture evaluation model includes in response to a determination that at least one posture metric among the one or more posture metrics does not satisfy an adaptive condition, determining the sitting posture of the user as a bad sitting posture; or in response to a determination that each of the one or more posture metrics satisfies the corresponding adaptive condition, determining the sitting posture of the user as a good sitting posture.

In some embodiments, the at least one processor is further configured to cause the system to perform operations including displaying the multiple 3D human pose keypoints to the user.

In some embodiments, the at least one processor is further configured to cause the system to perform operations including in response to a determination that the sitting posture of the user is a bad sitting posture, creating and recommending a recommendation plan to alert the user to a specific posture abnormality or an ideal change to be made to correct posture.

According to a second aspect of the present disclosure, a method for sitting posture evaluation is provided. The method is implemented on a computing device having at least one processor and at least one storage device. The method comprises when a user is sitting in front of a digital device that is equipped with a camera facing the user, obtaining one or more image frames of the user captured by the camera; and evaluating, based on the one or more image frames of the user, a sitting posture of the user using a posture evaluation model.

According to a third aspect of the present disclosure, a non-transitory computer readable medium for sitting posture evaluation is provided. The non-transitory computer readable medium comprises at least one set of instructions, wherein when executed by at least one processor of a computing device, the at least one set of instructions direct the at least one processor to perform operations including: when a user is sitting in front of a digital device that is equipped with a camera facing the user, obtaining one or more image frames of the user captured by the camera; and evaluating, based on the one or more image frames of the user, a sitting posture of the user using a posture evaluation model.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary sitting posture evaluation system according to some embodiments of the present disclosure;

FIG. 2 is a block diagram illustrating an exemplary processing device according to some embodiments of the present disclosure;

FIG. 3 is a flowchart illustrating an exemplary process for sitting posture evaluation according to some embodiments of the present disclosure;

FIG. 4A to FIG. 4F are schematic diagrams of exemplary posture metrics of a user when the user is sitting in front of a digital device that is equipped with a camera facing the user; and

FIG. 5 is a flowchart illustrating an exemplary process for sitting posture evaluation according to some embodiments of the present disclosure.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, sections or assembly of different levels in ascending order. However, the terms may be displaced by another expression if they achieve the same purpose.

It will be understood that, although the terms “first,” “second,” “third,” etc., may be used herein to describe various elements, these elements should not be limited by these terms. These terms are only used to distinguish one element from another. For example, a first element could be termed a second element, and, similarly, a second element could be termed a first element, without departing from the scope of exemplary embodiments of the present disclosure.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in an inverted order, or simultaneously. Moreover, one or more other operations may be added to the flowcharts. One or more operations may be removed from the flowcharts.

Provided herein are systems and methods for sitting posture evaluation. For example, the methods may include when a user is sitting in front of a digital device that is equipped with a camera facing the user, obtaining one or more image frames of the user captured by the camera. The methods may further include evaluating, based on the one or more image frames of the user, a sitting posture of the user using a posture evaluation model.

According to some embodiments of the present disclosure, since the image frames of the user can be acquired by the camera equipped by the digital device in front of which the user sits, and the sitting posture of the user can be evaluated merely based on the image frames of the user, it does not need any additional sensors to capture user's sitting posture, and does not need any additional devices to be worn by the user, thus the user does not need to conduct any extensive calibration of the additional devices, thereby facilitating the user operation and saving costs. Moreover, by using the posture evaluation model to evaluate the sitting posture of the user, the systems and the methods can quickly detect the user's sitting posture and present a personalized alert to the user (e.g., running in real-time with a latency of under one second between the detection of sitting posture and presenting the alert to the user), so that the user can know his/her sitting posture in real-time and adjust his/her sitting posture according to a corresponding recommendation, thereby improving the user experience.

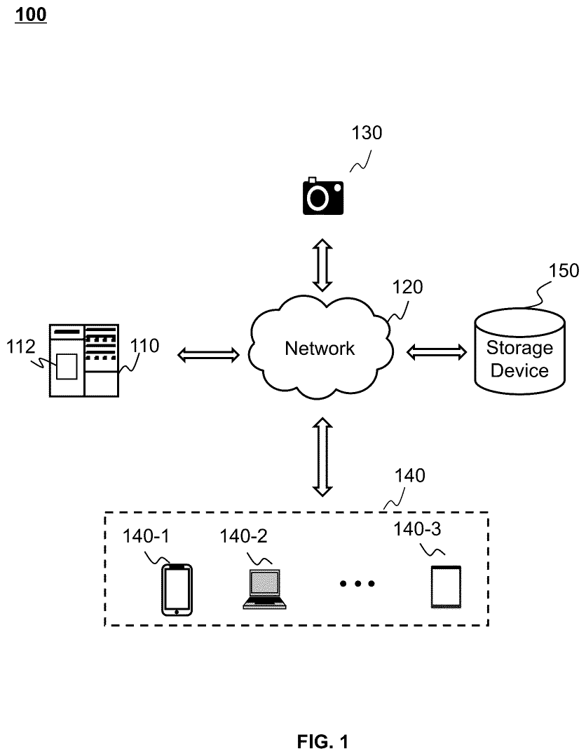

FIG. 1 is a schematic diagram illustrating an exemplary sitting posture evaluation system according to some embodiments of the present disclosure. As shown in FIG. 1, the sitting posture evaluation system 100 may include a server 110, a network 120, a camera 130, a digital device 140, and a storage device 150.

The server 110 may be a single server or a server group. The server group may be centralized or distributed (e.g., the server 110 may be a distributed system). In some embodiments, the server 110 may be local or remote. In some embodiments, the server 110 may be implemented on a cloud platform. In some embodiments, the server 110 may be implemented on a computing device.

In some embodiments, the server 110 may include a processing device 112. The processing device 112 may process data and/or information relating to sitting posture evaluation to perform one or more functions described in the present disclosure. For example, when a user is sitting in front of a digital device that is equipped with a camera facing the user, the processing device 112 may obtain one or more image frames of the user captured by the camera. Further, the processing device 112 may evaluate, based on the one or more image frames of the user, a sitting posture of the user using a posture evaluation model. In some embodiments, the processing device 112 may include one or more processing engines (e.g., single-core processing engine(s) or multi-core processor(s)).

In some embodiment, the server 110 may be unnecessary and all or part of the functions of the server 110 may be implemented by other components (e.g., the camera 130, the digital device 140) of the sitting posture evaluation system 100. For example, the processing device 112 may be integrated into the camera 130 or the digital device 140 and the functions of the processing device 112 may be implemented by the camera 130 (e.g., an image signal processor (ISP) in the camera 130) or the digital device 140.

The network 120 may facilitate the exchange of information and/or data for the sitting posture evaluation system 100. In some embodiments, one or more components (e.g., the server 110, the camera 130, the digital device 140, or the storage device 150) of the sitting posture evaluation system 100 may transmit information and/or data to one or more other components of the sitting posture evaluation system 100 via the network 120. For example, the server 110 may obtain/acquire image frames or video frames from the camera 130 via the network 120. As another example, the camera 130 may transmit image frames to the storage device 150 for storage via the network 120. In some embodiments, the network 120 may be any type of wired or wireless network, or a combination thereof.

The camera 130 may be configured to acquire at least one image frame (the “image frame” herein refers to a single image or a frame of a video). In some embodiments, the camera 130 may include a plurality of components each of which can acquire an image. For example, the camera 130 may include a plurality of sub-cameras that can capture images or videos simultaneously. In some embodiments, the camera 130 may transmit the acquired image frame to one or more components (e.g., the server 110, the digital device 140, and/or the storage device 150) of the sitting posture evaluation system 100 via the network 120. In some embodiments, the camera 130 may be integrated into the digital device 140.

The digital device 140 may be configured to receive information and/or data from the server 110, the camera 130, and/or the storage device 150 via the network 120. For example, the digital device 140 may receive images and/or videos from the camera 130. As another example, the digital device 140 may transmit instructions to the camera 130 and/or the server 110. In some embodiments, the digital device 140 may provide a user interface via which a user may view information and/or input data and/or instructions to the sitting posture evaluation system 100. For example, the user may view, via the user interface, information (e.g., pose keypoints) associated with a sitting posture of a user. As another example, the user may input, via the user interface, an instruction to set a customized recommendation plan of the camera 130. In some embodiments, the digital device 140 may include a mobile device 140-1, a computer 140-2, a tablet 140-3, or the like, or any combination thereof. In some embodiments, the digital device 140 may include a display that can display information in a human-readable form, such as text, image, audio, video, graph, animation, or the like, or any combination thereof. In some embodiments, the digital device 140 may be connected to one or more components (e.g., the server 110, the camera 130, and/or the storage device 150) of the sitting posture evaluation system 100 via the network 120.

The storage device 150 may be configured to store data and/or instructions. The data and/or instructions may be obtained from, for example, the server 110, the camera 130, and/or any other component of the sitting posture evaluation system 100. In some embodiments, the storage device 150 may store data and/or instructions that the server 110 may execute or use to perform exemplary methods described in the present disclosure. In some embodiments, the storage device 150 may include a mass storage device, a removable storage device, a volatile read-and-write memory, a read-only memory (ROM), or the like, or any combination thereof. In some embodiments, the storage device 150 may be implemented on a cloud platform.

It should be noted that the above description is intended to be illustrative, and not to limit the scope of the present disclosure. Many alternatives, modifications, and variations will be apparent to those skilled in the art. The features, structures, methods, and characteristics of the exemplary embodiments described herein may be combined in various ways to obtain additional and/or alternative exemplary embodiments. In some embodiments, the sitting posture evaluation system 100 may include one or more additional components and/or one or more components described above may be omitted. In some embodiments, two or more components of the sitting posture evaluation system 100 may be integrated into a single component. In some embodiments, a component of the sitting posture evaluation system 100 may be replaced by another component that can implement the functions of the component. However, those variations and modifications do not depart from the scope of the present disclosure.

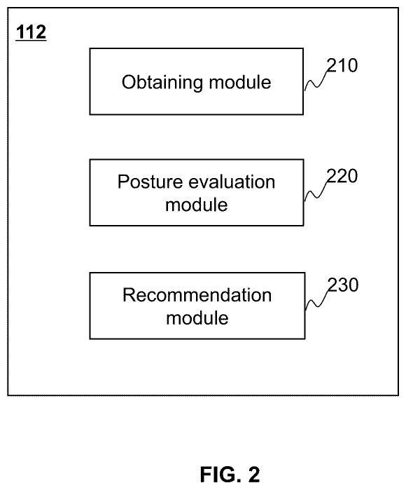

FIG. 2 is a block diagram illustrating an exemplary processing device according to some embodiments of the present disclosure. As illustrated in FIG. 2, the processing device 112 may include an obtaining module 210, a posture evaluation module 220, and a recommendation module 230.

The obtaining module 210 may be configured to obtain information or data associated with the sitting posture evaluation system 100. For example, when a user is sitting in front of a digital device that is equipped with a camera facing the user, the obtaining module 210 obtains one or more image frames of the user captured by the camera. As another example, the obtaining module 210 obtains a posture evaluation model configured to evaluate a sitting posture of the user.

The posture evaluation module 220 may be configured to evaluate, based on the one or more image frames of the user, a sitting posture of the user using the posture evaluation model.

The recommendation module 230 may be configured to recommend a plan to the user based on an evaluation result of the sitting posture of the user.

The modules in the processing device 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof.

It should be noted that the above description is merely provided for the purposes of illustration, and is not intended to limit the scope of the present disclosure. For persons having ordinary skills in the art, multiple variations and modifications may be made under the teachings of the present disclosure. For example, two or more of the modules are combined as a single module, and any one of the modules is divided into two or more units. As another example, the processing device 112 include one or more additional modules, such as a storage module (not shown) for storing data. However, those variations and modifications do not depart from the scope of the present disclosure.

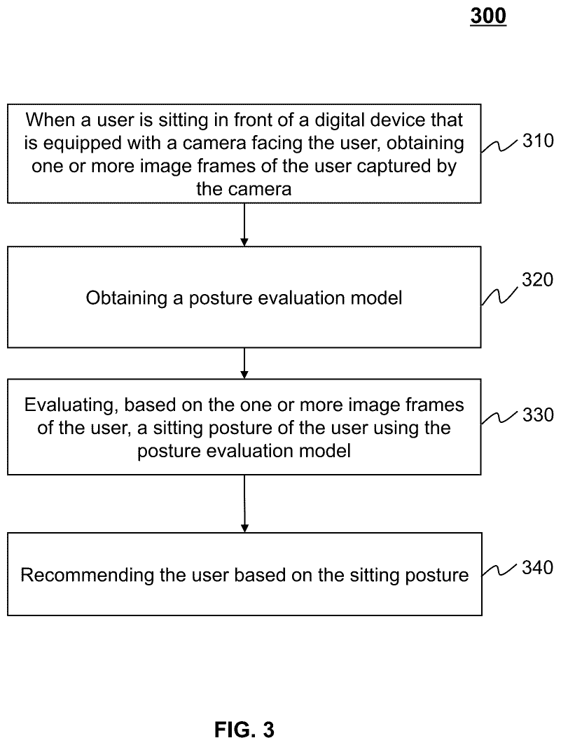

FIG. 3 is a flowchart illustrating an exemplary process for sitting posture evaluation according to some embodiments of the present disclosure. In some embodiments, process 300 is implemented as a set of instructions (e.g., an application) stored in a storage device (e.g., the storage device 150), and the processing device 112 and/or the modules in FIG. 2 executes the set of instructions and accordingly is directed to perform the process 300.

In 310, when a user is sitting in front of a digital device that is equipped with a camera facing the user, the processing device 112 (e.g., the obtaining module 210) may obtain one or more image frames of the user captured by the camera.

In some embodiments, the digital device includes a desktop, a laptop, an IPAD, a tablet, a phone, etc. The camera equipped in the digital device may capture its shooting range periodically or in real time to obtain the image frames. Specifically, when the user is sitting on an object (such as a chair, a couch, a bench, etc.), the user may put the digital device on a platform (e.g., a desk, a table, etc.) before the user to enable the camera facing the user. Since the camera faces the user, the image frames captured by the camera includes information of the front of the user when the user is sitting. It should be noted that the camera facing the user in the present disclosure refers that an angle between a straight-ahead direction and a direction the digital device pointing to the user is an acute angle (e.g., less than 70°, 50°, 30°, 10°, etc.). In some embodiments, the processing device 112 may update the image frames in real time or periodically.

In some embodiments, the camera of the digital device is triggered to capture the image frames through a browser or an application program (APP) that allows the user to access the sitting posture evaluation system 100. The user accesses the sitting posture evaluation system 100 through an Internet connection. For example, the user may connect and log in to a webpage (or a website) to access the sitting posture evaluation system 100. The user may trigger the camera to capture the image frames by clicking a trigger button in the webpage. As another example, in response to the user accessing the sitting posture evaluation system 100 via a browser to allow the sitting posture evaluation system 100 to connect the camera, the processing device 112 may control the camera to capture the one or more image frames. As a further example, the user may download the APP in the digital device. The user may register and log in his/her own account. The user may trigger the camera to capture the image frames through the APP when the user is sitting in front of the digital device.

According to some embodiments of the present disclosure, by triggering the camera through the Internet connection to capture the image frames of the user, the user does not need to transmit the image frames to a public or private cloud, thereby protecting the user's privacy.

In some embodiments, after the user accesses the sitting posture evaluation system 100 through the Internet connection, the system continues to perform the sitting posture evaluation even if the Internet connection is disconnected.

In 320, the processing device 112 (e.g., the obtaining module 210) may obtain a posture evaluation model.

In some embodiments, the posture evaluation model is a deep learning network trained based on a plurality of groups of training data. Each group of training data includes a sample image frame, and during the training, the label is a manually determined sitting posture, such as a bad sitting posture or a good sitting posture. In some embodiments, the training of the posture evaluation model is performed by another device or system other than the sitting posture evaluation system 100, e.g., a device or system of a vendor of a manufacturer.

In some embodiments, the posture evaluation model may include a convolutional neural network (CNN) model, a generative adversarial network (GAN) model, a fully convolutional neural network (FCN) (e.g., a U-Net, a V-Net), a recurrent neural network (RNN), a diffusion model, a transformer, or the like, or any combination thereof.

In some embodiments, the posture evaluation model is composed of a 3D pose detection model and a posture metric determination model. An output layer of the 3D pose detection model is connected to an input layer of the posture metric determination model. For example, the output layer of the 3D pose detection model and the input layer of the posture metric determination model are the same layer.

The 3D pose detection model is configured to detect multiple 3D human pose keypoints in each image frame of the one or more image frames. In some embodiments, the multiple 3D human pose keypoints in each image frame include points corresponding to the users'elbows, shoulders, hands, legs, face, forehead, neck (e.g., middle of the neck), nose, skull, bottom of the spine, etc. The 3D pose detection model is a deep learning network trained based on a plurality of groups of training data. Each group of training data includes a sample image frame, and during the training, the label is a manually determined 3D human pose keypoints. In some embodiments, the 3D pose detection model includes a Blaze Pose GHUM 3D model, etc.

In some embodiments, the 3D pose detection model is further configured to detect one or more aspects of an environment in which the user is located. In some embodiments, the one or more aspects of the environment include an edge of the platform (e.g., a desk), a location of the object (e.g., a chair) in which the user is sitting, etc.

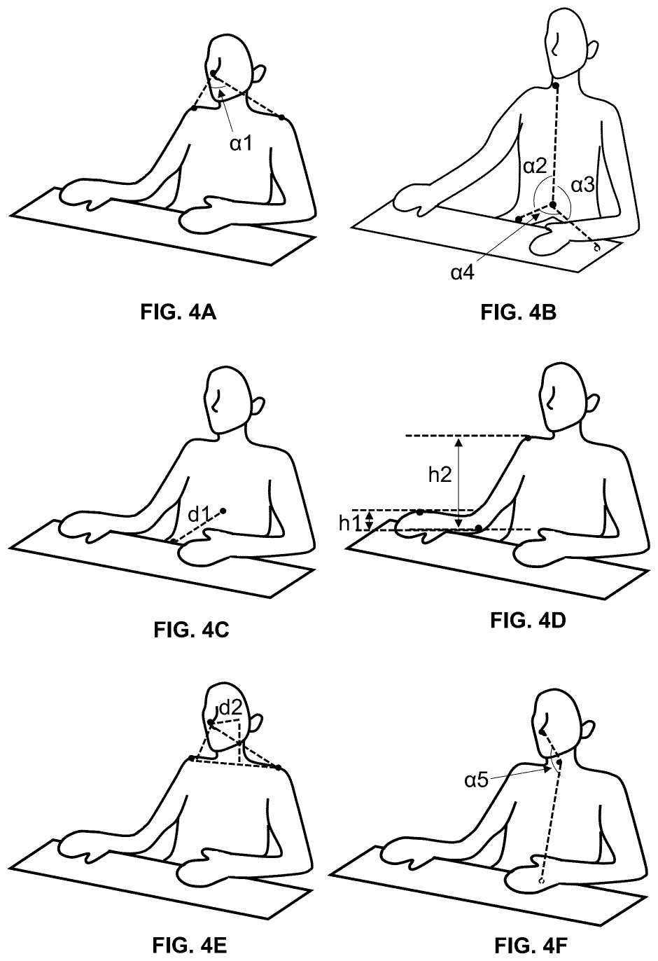

The posture metric determination model is configured to determine one or more posture metrics at least based on the multiple 3D human pose keypoints in the each image frame. As used herein, the posture metric refers to a parameter that can be used to evaluate the sitting posture of the user. FIG. 4A to FIG. 4F are schematic diagrams of exemplary posture metrics of a user when the user is sitting in front of a digital device that is equipped with a camera facing the user. In some embodiments, the posture metrics may include an angle formed by the user's shoulders and nose, with the nose as a vertex (e.g., angle α1 as shown in FIG. 4A); angles formed by the user's legs, bottom of the user's spine, and middle of the neck, with the bottom of the spine as a vertex (e.g., angles α2, α3, α4 as shown in FIG. 4B); a distance between the user (e.g., the back of the user) and the edge of the platform (e.g., a desk) (e.g., distance d1 as shown in FIG. 4C); relative heights of the user's elbows, hands, and shoulders (e.g., heights h1 and h2 as shown in FIG. 4D); how far back the shoulders are relative to a front side of the user's skull (e.g., distance d2 as shown in FIG. 4E); an angle of neck lean from the bottom of the spine, the middle of the neck, and the front side of the skull, with the middle of the neck as a vertex (e.g., angle α5 as shown in FIG. 4F); an elbow height relative to the platform; a height of each shoulder of the user relative to the user's neck; or the like, or any combination thereof.

In 330, the processing device 112 (e.g., the posture evaluation module 220) may evaluate, based on the one or more image frames of the user, a sitting posture of the user using the posture evaluation model.

In some embodiments, the processing device 112 inputs the one or more image frames into the posture evaluation model, and the posture evaluation model outputs an evaluation result of the sitting posture of the user. For example, the posture evaluation model may output that the sitting posture of the user is a good sitting posture or a bad sitting posture. In some embodiments, before inputting the image frames into the posture evaluation model, the processing device 112 scales the image frames in terms of size to improve processing efficiency of the posture evaluation model.

In some embodiments, if the posture evaluation model is composed of the 3D pose detection model and the posture metric determination model, the posture metric determination model may output the posture metrics. The processing device 112 may determine whether each of the one or more posture metrics satisfies a corresponding adaptive condition. In response to a determination that at least one posture metric does not satisfy the corresponding adaptive condition, the processing device 112 determines the sitting posture of the user as a bad sitting posture. In response to a determination that each posture metric satisfies the corresponding adaptive condition, the processing device 112 determines the sitting posture of the user as a good sitting posture.

In some embodiments, the adaptive condition corresponding to each posture metric may be set according to a default setting of the sitting posture evaluation system 100 or preset by the user or operator via the digital device 140. Different posture metrics correspond to different adaptive conditions. For example, for the posture metric being a distance between the user and the edge of the platform, the corresponding adaptive condition is that the distance between the user and the edge of the platform is within a distance range (e.g., less than 30 cm and greater than 2 cm). As another example, for the posture metric being an angle of neck lean from the bottom of the spine, the middle of the neck, and the front side of the skull, the corresponding adaptive condition is that the angle is greater than an angle threshold (e.g., 120°, 130°, 140°, 150°, etc.). In some embodiments, different users correspond to different adaptive conditions. For example, the adaptive condition varies based on the user-setting of sensitivity.

In some embodiments, the processing device 112 further obtains user information, and evaluates the sitting posture of the user using the posture evaluation model based on the one or more image frames of the user and the user information. In some embodiments, the user information may include race, age, gender, etc., of the user. For example, the processing device 112 updates the adaptive condition corresponding to each posture metric based on the user information. The processing device 112 evaluates the sitting posture of the user according to the updated adaptive condition.

In some embodiments, to improve the accuracy of the evaluation result, the processing device 112 obtains additional image frames acquired by an additional camera with a different capturing angle relative to the camera. The processing device 112 evaluates the sitting posture of the user using the posture evaluation model based on the one or more image frames and additional image frames of the user.

In 340, the processing device 112 (e.g., the recommendation module 230) recommends a recommendation plan to the user based on the evaluation result of the sitting posture of the user.

The recommendation plan is configured to alert the user to a specific sitting posture abnormality and an ideal change to be made to correct sitting posture. In some embodiments, the recommendation plan is created customized. For example, user preferences are used to alert the user visually or through an audio alert. Once such an alert or recommendation plan is presented to the user, a user-defined interval of time may be applied before any further alert is generated. The purpose of this interval of time is to avoid overwhelming the user with the same alert repeatedly.

In some embodiments, the processing device 112 further identifies a user fatigue status from the image frames. The processing device 112 creates the recommendation plan based on the user fatigue status and the evaluation result. For example, when the user fatigue status indicates that the user is fatigue, even if the sitting posture of the user is determined as the good sitting posture, the processing device 112 is also recommend the user to take a rest. In some embodiments, the processing device 112 may identify the user fatigue status by identifying the user's eye condition or counting a duration of screen staring.

It should be noted that the process 300 can be continuously repeated as long as the user is in front of the digital device. Thus, when the sitting posture of the user is abnormal, he/she can immediately know his/her sitting posture, thereby ensuring that the user can correct his/her sitting posture immediately.

It should be noted that in some embodiments, the method for sitting posture evaluation can be applied in a scenario that a driver is sitting in a car cab. The image frames of the driver are captured by an onboard camera installed at the front of the vehicle. Thus, the processing device 112 evaluates the sitting posture of the driver based on the image frames using the posture evaluation model. Further, the processing device 112 reminds the driver of his/her sitting posture and safety precautions.

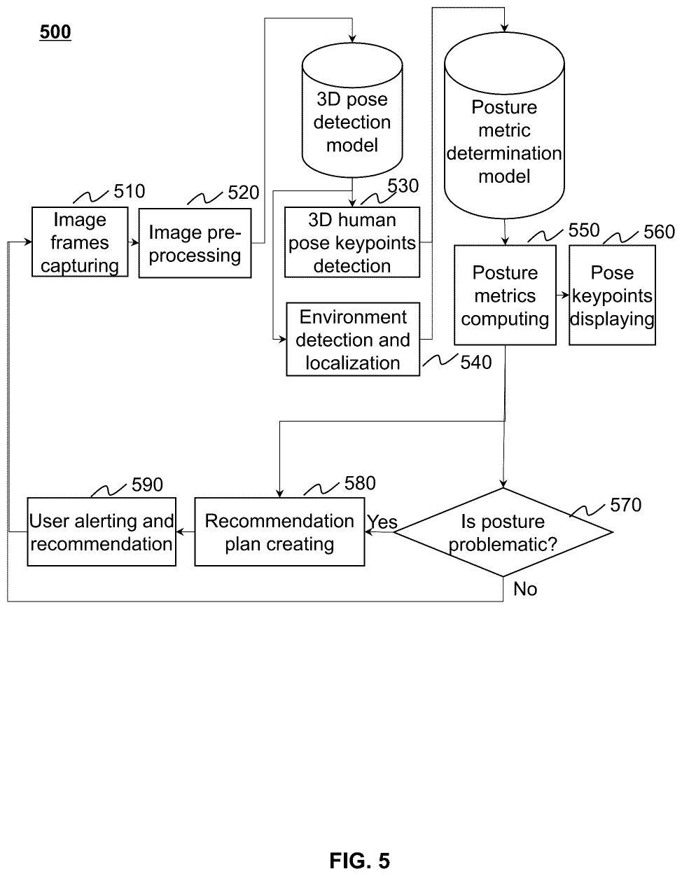

FIG. 5 is a flowchart illustrating an exemplary process for sitting posture evaluation according to some embodiments of the present disclosure. In some embodiments, process 500 may be implemented as a set of instructions (e.g., an application) stored in a storage device (e.g., the storage device 150), and the processing device 112 and/or the modules in FIG. 2 may execute the set of instructions and may accordingly be directed to perform the process 500.

In 510, when a user is sitting in front of a digital device that is equipped with a camera facing the user, the processing device 112 (e.g., the obtaining module 210) obtains one or more image frames of the user captured by the camera. The processing device 112 may obtain the one or more image frames of the user captured by the camera in connection with operation 310 in FIG. 3.

In 520, the processing device 112 (e.g., the obtaining module 210) pre-processes the image frames. For example, the processing device 112 may perform a denoising operation on the image frames. As another example, the processing device 112 may scale each image frame in terms of size to improve processing efficiency of subsequent operations. In some embodiments, operation 520 can be omitted.

In 530, the processing device 112 (e.g., the posture evaluation module 220) detects multiple 3D human pose keypoints in each image frame using a 3D pose detection model. For example, the 3D pose detection model is used to track three dimensional coordinates of the user's 33 skeletal points from each image frame.

In 540, the processing device 112 (e.g., the posture evaluation module 220) detects, using the 3D pose detection model, one or more aspects of the environment in which the user is located, such as an edge of a platform, a location of the object (e.g., a chair) in which the user is sitting, etc.

In 550, the processing device 112 (e.g., the posture evaluation module 220) computes, based on the multiple 3D human pose keypoints in the each image frame and the one or more aspects of the environment, one or more posture metrics using a posture metric determination model.

In 560, the processing device 112 (e.g., the posture evaluation module 220) displays the 3D human pose keypoints to the user.

In 570, the processing device 112 (e.g., the posture evaluation module 220) determines whether the sitting posture of the user is problematic. Specifically, the processing device 112 determines whether each of the one or more posture metrics satisfies a corresponding adaptive condition. In response to a determination that at least one posture metric does not satisfy the corresponding adaptive condition, the processing device 112 determines the sitting posture of the user as a bad sitting posture, and proceeds back to perform operation 510. In response to a determination that each posture metric satisfies the corresponding adaptive condition, the processing device 112 determines the sitting posture of the user as a good sitting posture, and proceeds to perform operation 580.

In 580, the processing device 112 (e.g., the recommendation module 230) creates a recommendation plan. In some embodiments, the recommendation plan is customized by the user. For example, the user may set the recommendation plan to be presented in a form of a special voice or text.

In 590, the processing device 112 (e.g., the recommendation module 230) alerts the user and/or recommends the recommendation plan to the user. After the operation 590, the processing device 112 proceeds to perform operation 510 again.

The operations of the illustrated processes 300 and 500 presented above are intended to be illustrative. In some embodiments, a process may be accomplished with one or more additional operations not described, and/or without one or more of the operations discussed. Additionally, the order in which the operations of a process described above is not intended to be limiting.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system. ” Furthermore, aspects of the present disclosure may take the form of a computer program product embodied in one or more computer-readable media having computer-readable program code embodied thereon.

A non-transitory computer-readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer-readable signal medium may be any computer-readable medium that is not a computer-readable storage medium and that may communicate, propagate, or transport a program for use by or in connection with an instruction execution system, apparatus, or device. Program code embodied on a computer-readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran, Perl, COBOL, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof to streamline the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially. ” For example, “about,” “approximate” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A system, comprising:
at least one storage device storing executable instructions for sitting posture evaluation; and
at least one processor in communication with the at least one storage device, wherein when executing the executable instructions, the at least one processor is configured to cause the system to perform operations including:
when a user is sitting in front of a digital device that is equipped with a camera facing the user, obtaining one or more image frames of the user captured by the camera; and
evaluating, based on the one or more image frames of the user, a sitting posture of the user using a posture evaluation model.

2. The system of claim 1, wherein the obtaining one or more image frames of the user includes:
in response to the user accessing the system via a browser to allow the system to connect to the camera, controlling the camera to capture the one or more image frames.

3. The system of claim 2, wherein the user accesses the system through an Internet connection, and the system continues to perform the operations even if the Internet connection is disconnected.

4. The system of claim 1, wherein after obtaining one or more frames of the user, the at least one processor is further configured to cause the system to perform operations including:
scaling each frame of the one or more frames of the user in terms of a threshold size.

5. The system of claim 1, wherein the posture evaluation model includes:
a 3D pose detection model at least configured to detect multiple 3D human pose keypoints in each image frame of the one or more image frames; and
a posture metric determination model configured to determine one or more posture metrics at least based on the multiple 3D human pose keypoints in the each image frame, wherein an output layer of the 3D pose detection model is connected to an input layer of the posture metric determination model.

6. The system of claim 5, wherein the 3D pose detection model is further configured to detect one or more aspects of an environment in which the user is located.

7. The system of claim 6, wherein the one or more aspects of the environment include an edge of a desk or a location of an object in which the user is sitting.

8. The system of claim 7, wherein the one or more posture metrics include at least one of:
an elbow height relative to the desk;
a height of each shoulder of the user relative to the user's neck;
an angle formed by the user's shoulders and nose, with the nose as a vertex;
angles formed by the user's legs, bottom of the user's spine, and middle of the neck, with the bottom of the spine as a vertex;
a distance between the user and the desk;
relative heights of the user's elbows, hands, and shoulders;
how far back the shoulders are relative to a front side of the user's skull; or
an angle of neck lean from the bottom of the spine, the middle of the neck, and the front side of the skull, with the middle of the neck as a vertex.

9. The system of claim 5, wherein the evaluating, based on the one or more image frames of the user, a sitting posture of the user using a posture evaluation model includes:
in response to a determination that at least one posture metric among the one or more posture metrics does not satisfy an adaptive condition, determining the sitting posture of the user as a bad sitting posture; or
in response to a determination that each of the one or more posture metrics satisfies the corresponding adaptive condition, determining the sitting posture of the user as a good sitting posture.

10. The system of claim 5, wherein the at least one processor is further configured to cause the system to perform operations including:
displaying the multiple 3D human pose keypoints to the user.

11. The system of claim 1, wherein the at least one processor is further configured to cause the system to perform operations including:
in response to a determination that the sitting posture of the user is a bad sitting posture, creating and recommending a recommendation plan to alert the user to a specific posture abnormality or an ideal change to be made to correct posture.

12. A method for sitting posture evaluation, implemented on a computing device having at least one processor and at least one storage device, the method comprising:
when a user is sitting in front of a digital device that is equipped with a camera facing the user, obtaining one or more image frames of the user captured by the camera; and
evaluating, based on the one or more image frames of the user, a sitting posture of the user using a posture evaluation model.

13. The method of claim 12, wherein the obtaining one or more image frames of the user includes:
in response to the user accessing the system via a browser to allow the system to connect to the camera, controlling the camera to capture the one or more image frames.

14. The method of claim 13, wherein the user accesses the system through an Internet connection, and the system continues to perform the operations even if the Internet connection is disconnected.

15. The method of claim 12, wherein the posture evaluation model includes:
a 3D pose detection model at least configured to detect multiple 3D human pose keypoints in each image frame of the one or more image frames; and
a posture metric determination model configured to determine one or more posture metrics at least based on the multiple 3D human pose keypoints in the each image frame, wherein an output layer of the 3D pose detection model is connected to an input layer of the posture metric determination model.

16. The method of claim 15, wherein the 3D pose detection model is further configured to detect one or more aspects of an environment in which the user is located.

17. The method of claim 16, wherein the one or more aspects of the environment include an edge of a desk or a location of an object in which the user is sitting.

18. The method of claim 17, wherein the one or more posture metrics include at least one of:
an elbow height relative to the desk;
a height of each shoulder of the user relative to the user's neck;
an angle formed by the user's shoulders and nose, with the nose as a vertex;
angles formed by the user's legs, bottom of the user's spine, and middle of the neck, with the bottom of the spine as a vertex;
a distance between the user and the desk;
relative heights of the user's elbows, hands, and shoulders;
how far back the shoulders are relative to a front side of the user's skull; or
an angle of neck lean from the bottom of the spine, the middle of the neck, and the front side of the skull, with the middle of the neck as a vertex.

19. The method of claim 15, wherein the evaluating, based on the one or more image frames of the user, a sitting posture of the user using a posture evaluation model includes:
in response to a determination that at least one posture metric among the one or more posture metrics does not satisfy an adaptive condition, determining the sitting posture of the user as a bad sitting posture; or
in response to a determination that each of the one or more posture metrics satisfies the corresponding adaptive condition, determining the sitting posture of the user as a good sitting posture.

20. A non-transitory computer readable medium, comprising at least one set of instructions for sitting posture evaluation, wherein when executed by at least one processor of a computing device, the at least one set of instructions direct the at least one processor to perform operations including:
when a user is sitting in front of a digital device that is equipped with a camera facing the user, obtaining one or more image frames of the user captured by the camera; and
evaluating, based on the one or more image frames of the user, a sitting posture of the user using a posture evaluation model.
